(19) United States
(12) Patent Application Publication
(10) Pub. No.: US 2013/0213560 A1
(43) Pub. Date: Aug. 22, 2013

(54) METHOD FOR PRODUCING PARTS MADE FROM COMPOSITE MATERIALS WITH A BRAIDED COVERING

(71) Applicants: Richard Masson, Les Loges En Josas (FR); Bertrand Desjoyeaux, Sainte Adresse (FR); Patrick Dunleavy, Palaiseau (FR)

(72) Inventors: Richard Masson, Les Loges En Josas (FR); Bertrand Desjoyeaux, Sainte Adresse (FR); Patrick Dunleavy, Palaiseau (FR)

(73) Assignees: AIRCELLE, Gonfreville-l'Orcher (FR); MESSIER-BUGATTI-DOWTY, VELIZY VILLACOUBLAY (FR)

(21) Appl. No.: 13/820,936

(22) PCT Filed: Sep. 6, 2011
(86) PCT No.: PCT/EP11/65397

§ 371 Date: May 3, 2013

(30) Foreign Application Priority Data
Sep. 6, 2010 (FR) 10 57071

(51) Int. Cl. B29D 23/00

(52) U.S. Cl. CPC B29D 23/00
USPC 156/148

(57) ABSTRACT

The invention relates to a method of making a composite material part, the method comprising the steps of:
producing a mandrel;
braiding a fiber covering (11) around the mandrel fitting as closely as possible to the shapes of the mandrel;
locally applying at least one fiber patch (12a, 12b, 12c) on the braided covering;
repeating the two steps of braiding and patch application as often as needed to obtain a preform; and
delivering resin into the preform and polymerizing it.

The invention relates to a method of fabricating composite material parts with a braided covering.

### TECHNOLOGICAL BACKGROUND

Parts are known that are fabricated with the help of a hollow mandrel that is passed through the central orifice of a braiding machine so as to cover the mandrel in one or more coverings of braided fibers. The resulting assembly is then subjected to resin infusion or injection and is then heated in order to polymerize the resin.

Nevertheless, braiding does not enable large variations of thickness to be obtained in the coverings made in that way. At best, by slowing down the speed at which the mandrel passes through the braiding machine, it is possible to increase the thickness of the braiding covering marginally. That makes it difficult, or even impossible, to use braiding to make parts having thicknesses that vary locally.

Document FR 2 890 591 proposes making a part having a fiber preform that is reinforced by pre-impregnated strips of monodirectional fiber fabric extending in a longitudinal direction of the part in order to reinforce said part, in particular in compression.

Document WO 2006/118448 discloses a method of reinforcing braided fiber parts, the method including the step of inserting flat reinforcing bodies that are positioned manually or with the help of a robot. Those flat reinforcements are constituted by a certain number of layers of fiber fabric that are secured to one another in a prior step of using a thermoplastic binder, the resulting assembly being subjected to high temperature and pressure. Nevertheless, that type of reinforcement presents the drawback of being very rigid.

### OBJECT OF THE INVENTION

An object of the invention is to provide a method of making composite material parts with braided coverings, which parts also include significant variations in thickness.

### BRIEF SUMMARY OF THE INVENTION

In order to achieve this object, the invention provides a method of making a composite material part, the method comprising the steps of:
producing a mandrel;
braiding a fiber covering around the mandrel fitting as closely as possible to the shapes of the mandrel;
locally applying at least one fiber patch onto the braided covering, each patch being shaped so as to present sufficient deformability to fit closely over the braided covering or the patch on which it is applied;
repeating the two steps of braiding and patch application as often as needed to obtain a preform;
braiding an outer braided covering covering the entire assembly; and
delivering resin into the preform and polymerizing it.

The method of the invention makes it possible to create local extra thicknesses in stressed locations of the part. In addition, instead of starting from a mandrel having greatly-varying shapes that are difficult to cover in one or more braided coverings, it is possible to start with a mandrel of smoother shape that is covered in a braided covering, and on which shapes that vary more significantly are constructed by locally stacking patches of fabric that have been cut out in order to obtain the desired shape and that are sufficiently deformable to fit closely to the shape on which they are applied.

The patches are cut out from pre-impregnated unidirectional fabrics or else they are cut out from dry fabrics, e.g. fabrics having a twill weave, since they are highly deformable. Impregnating the fabrics with a little resin contributes to shaping the patches before they are placed on the braided covering, by pre-polymerizing them while they are in shape. Where appropriate, the patch(es) may be made up of a plurality of thicknesses of fabric, providing only that the patch as made in this way remains sufficiently deformable to fit closely to the shape on which it is applied.

The braiding and patch application steps in the method of the invention may be repeated several times. It is thus possible at will to vary the fiber thickness in any zone of the preform.

### BRIEF DESCRIPTION OF THE FIGURES

The invention can be better understood in the light of the following description of a particular implementation of the method of the invention, given with reference to the figures of the accompanying drawings, in which:

FIG. 1 is a perspective view of a landing gear rocker beam made in accordance with the invention;

FIG. 2 is a fragmentary view of a mandrel already covered in a braided preform in order to produce the FIG. 1 rocker beam, and having patches of fabric fitted locally thereto in accordance with the invention;

FIG. 3 is an exploded view of the applied fabric patches;

FIG. 4 is a fragmentary view of the same mandrel covered in other fabric patches at another location;

FIG. 5 is a section view on plane V of FIG. 1, prior to machining the rocker beam;

FIG. 6 is a section view on plane VI of FIG. 1, prior to machining the rocker beam; and

FIG. 7 is a half-view in longitudinal section on plane VII of FIG. 1, after the rocker beam has been machined.

### DETAILED DESCRIPTION OF THE FIGURES

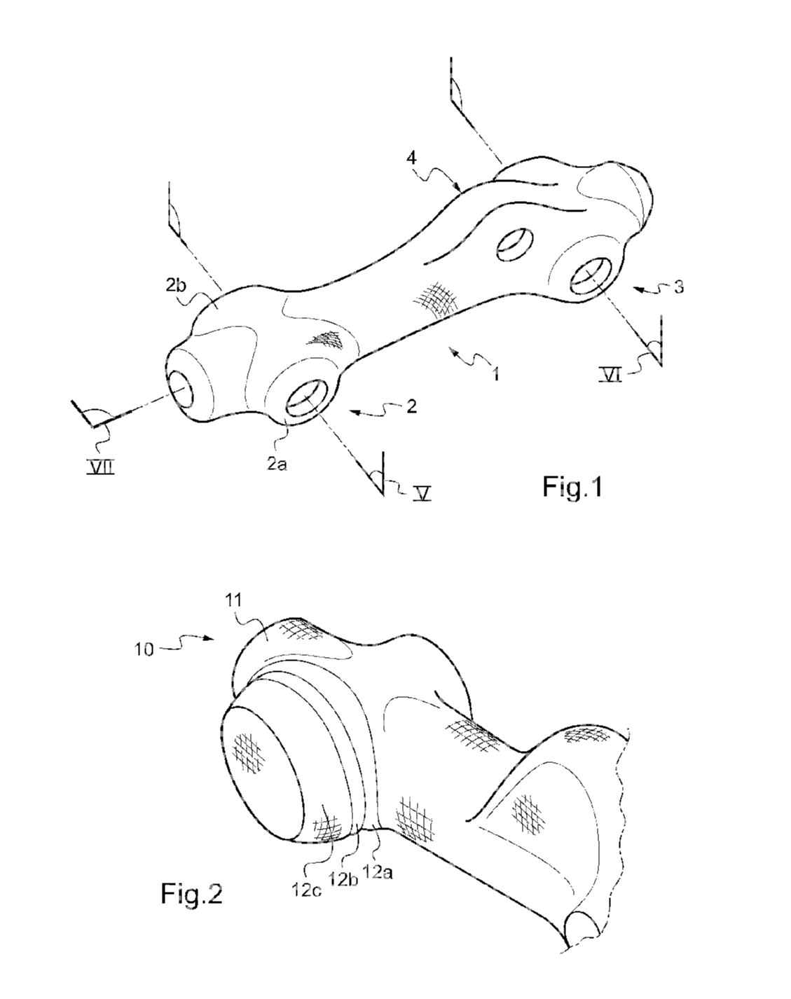

The invention is described below with reference to a landing gear rocker beam of the kind shown in FIG. 1 that comprises a body 1 with a first end 2 shaped to receive a pivot to hinge the rocker beam to the landing gear, and a second end 3 shaped to receive an axle that is to receive wheels. The rocker beam also has a lug 4 on its top portion for receiving a pin connected to a shock absorber.

As can clearly be seen, the first end has two projecting side bulges 2a and 2b in which orifices have been pierced for passing the pivot, these orifices being designed to be fitted with rings.

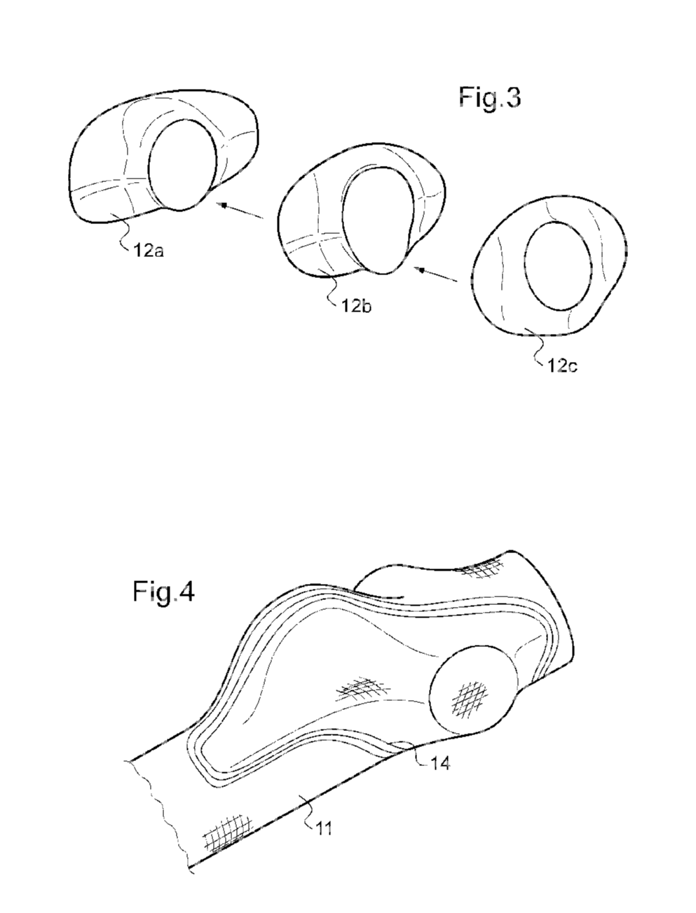

As shown in FIG. 2, the initial stage is to produce a mandrel 10 with shapes that vary progressively, and the first step is to cover it in a braided covering 11, made of carbon fiber in this example. Thereafter, on the mandrel as covered in this way, a series 12 of superposed patches are fitted to the locations where it is desired to give accentuated shapes or increased thicknesses to the assembly, each of the patches being cut out from a dry carbon fiber fabric. This example shows a series of patches 12a, 12b, and 12c that are superposed on one another and that cover one of the projections of the mandrel. On the other side, there can be seen the corresponding projection that is not yet covered in patches. The patches 12a, 12b, and 12c are shown in an exploded view in FIG. 3. The patches are preferably cut out from a twill fiber fabric. The twill weave is known for permitting fabric to be highly deformable, thus allowing the patch to be applied intimately against the shape that it is to cover. Thus, the patches are shaped by being applied intimately against the braided covering or the patch that they cover. In a particular implementation, the patches are shaped at least in part (as shell-shapes in this example) prior to being applied on the braid covering the mandrel, thereby assisting in putting the patches into place, and in particular in positioning them. For this purpose, it is advantageous to use a fabric that is pre-impregnated with resin, the patches being pre-polymerized while in shape prior to being applied to the braided covering. Nevertheless, care should be taken to ensure that the patches as preformed in this way remain sufficiently deformable to be capable of being applied as intimately as possible against the braided covering or the patch that they cover.

In similar manner, FIG. 4 shows the application of patches 14 against the braiding covering the mandrel at the lug 4. In this example, the patch covers both half of the lug 4 and the adjacent protuberance 3.

The patches are preferably held in position on the braid 11 covering the mandrel 10 by spraying resin, or by applying any other binder that enables the patches to be fastened on the mandrel in sufficiently secure manner to enable the mandrel 10 fitted with the patches in this way to be passed back through the braiding machine without the patches moving or becoming detached. The fibers of the patches are preferably oriented in such a manner as to be complementary to the orientation of the fibers of the braided coverings in order to optimize the final structure.

Then, for as many times as are required, the two steps of braiding and applying patches are repeated. The assembly made in this way is preferably covered in a final braid. Naturally, the stack of patches and of braided coverings built up in this way is selected so as to enable the assembly to be covered by a final outer braided covering. In particular, the outside shape advantageously varies progressively so as to limit sudden changes of thickness so that the final braid can fit closely over the outside shape. The same naturally applies to the intermediate braids.

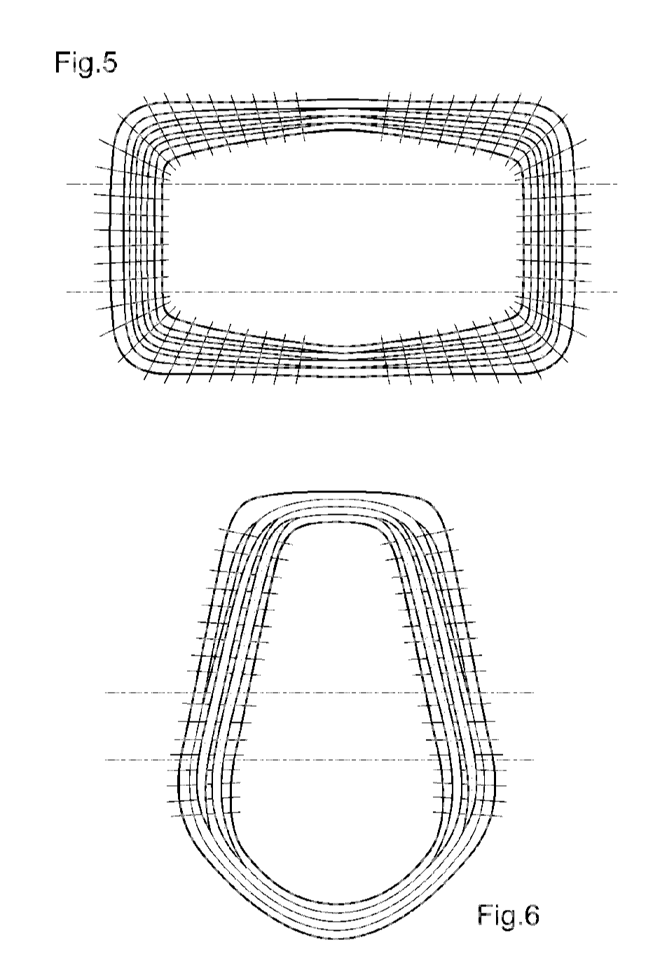

FIGS. 5 and 6 are diagrams showing the successive series of patches (shaded shapes) that are separated by braided coverings. In zones where patches accumulate, the initial shapes of the mandrel are transformed very considerably so as to end up with the shapes and thicknesses that are desired for the final part.

Advantageously, the zone as covered in patches in this way is reinforced, once stacking has terminated, by inserting transverse fibers (represented by transverse lines in FIGS. 5 and 6), e.g. by stitching or by seaming. This reinforcement contributes to holding the patches in place between the braided coverings prior to resin being injected and polymerized. The reinforcement remains permanently in place and thus forms an integral portion of the part once it has been finished, thereby greatly reducing any risk of delamination as a result of mounting the axle or the shaft that is to be inserted in the orifice machined through the reinforced zones.

The stitching is represented in FIGS. 5 and 6 by lines passing through the braided coverings and the (shaded) patches. In these figures, the patches have been stitched over their entire surfaces. Nevertheless, in the locations that are to be pierced (represented by chain-dotted lines), it is possible to omit any stitching.

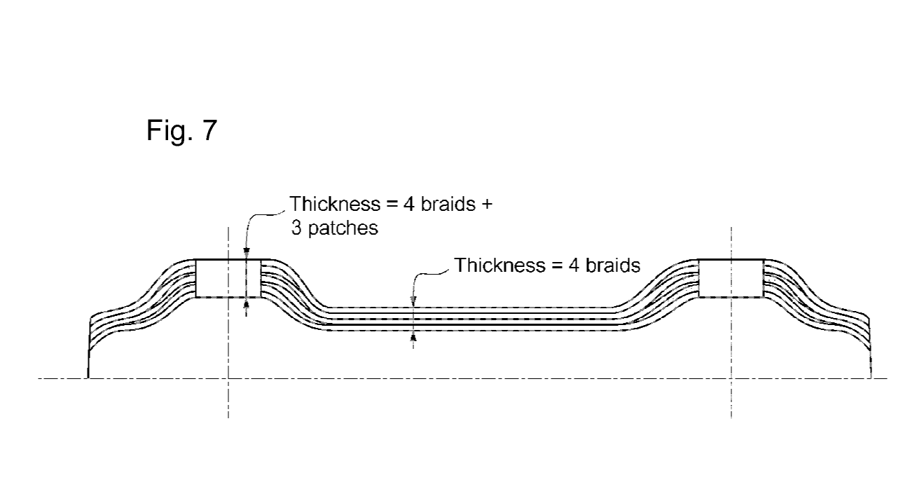

FIG. 7 shows how the rocker beam varies in thickness. In its central portion, the thickness of the main portion is made up of four braided layers, whereas in the portions 2 and 3, the thickness is constituted by four braided layers having three series of patches interposed between them (represented by shading).

The preform as constituted in this way receives resin by injection, infusion, or any other conventional method, and then the resin is polymerized in order to obtain the almost finished final part. The preform is preferably placed in a mold. The resin is injected into the mold, and then the assembly is subjected to heating, and also to isostatic compression, where appropriate. All that then remains to be done is to pierce the orifices and provide them with rings, where appropriate.

The invention is naturally not limited to the above description, but on the contrary covers any variant coming within the ambit defined by the claims. In particular, although the patches and the braids in this example are made of carbon fibers, the invention can naturally be generalized to any other technical fiber, such as glass or aramid fiber.

Although the patches in this example are cut out from twill fabric, the patches could be cut out from fabric having other weaves, or indeed from multilayer fabrics that are stitched so as to optimize the orientations of the fibers in the zones where the patches are applied as a function of the directions in which forces act. Naturally, the patches must remain sufficiently deformable to be capable of being applied as intimately as possible against the surfaces they cover. In another variant, the patches may be made by depositing a sheet of fibers, e.g. by an operation of using a robot mounted on the braiding machine to deposit filaments.

Although it is stated that the patches are held in place on the braided covering by spraying resin, they could also be stitched in situ using a yarn of the same nature as the fibers of the patch, or compatible therewith (e.g. a thermoplastic yarn).

The above-described braiding steps consist in applying a braided covering over the last stack of patches, and each braided covering may itself comprise one or more braided layers, possibly with the layers being joined together (interlocking).

Naturally, the invention applies to any part capable of being fabricated by braiding, such as a rocker beam that is to receive four or six wheels with a central hinge, a strut, or a connecting rod.

1. A method of making a composite material part, the method comprising the steps of:
producing a mandrel;
braiding a fiber covering (11) around the mandrel fitting as closely as possible to the shapes of the mandrel;
locally applying at least one fiber patch (12a, 12b, 12c; 14) onto the braided covering, each patch being shaped so as to present sufficient deformability to fit closely over the braided covering or the patch on which it is applied;
repeating the two steps of braiding and patch application as often as needed to obtain a preform;
braiding an outer braided covering covering the entire assembly; and
delivering resin into the preform and polymerizing it.

2. A method according to claim 1, wherein the patch is secured to the braided covering.

3. A method according to claim 2, wherein the securing step comprises pre-polymerizing resin.

4. A method according to claim 2, wherein the securing step comprises bonding by inserting fibers in a direction normal to the stack of the patch and the braided covering, the fibers being made to pass therethrough, e.g. by seaming or stitching.

5. A method according to claim 1, wherein the preform is placed in a mold, and then the resin is delivered into the mold and polymerized.

6. A method according to claim 1, wherein a plurality of patches are stacked on one another.
